(19) United States
(12) Patent Application Publication
(10) Pub. No.: US 2024/0054439 A1
(43) Pub. Date: Feb. 15, 2024

(54) SYSTEM AND METHOD FOR TRACING AND GUARANTEEING THE QUALITY OF RAW MATERIALS

(71) Applicant: THEMIS S.R.L., Bagnolo Mella (BS) (IT)

(72) Inventors: Graziano BELDRIGHI, Bagnolo Mella (BS) (IT); Matteo MOLINARI, Bagnolo Mella (BS) (IT)

(73) Assignee: THEMIS S.R.L., Bagnolo Mella (BS) (IT)

(21) Appl. No.: 18/268,832

(22) PCT Filed: Jan. 4, 2022
(86) PCT No.: PCT/EP2022/050095

§ 371 Date: Jun. 21, 2023

(30) Foreign Application Priority Data
Jan. 5, 2021 (IT) 102021000000149

(51) Int. Cl. G06Q 10/0833; G06K 19/06; G06K 7/14; G06Q 10/0832; G06Q 30/018

(52) U.S. Cl. CPC G06Q 10/0833; G06K 19/06037; G06K 7/1417; G06Q 10/0832; G06Q 30/018

(57) ABSTRACT

A system for tracing and guaranteeing the quality of raw materials and/or a transfer or exchange thereof, includes:
an analytical system configured to carry out at least one of a: chemical, chemical-physical or physical analysis on raw materials,
a label, including a code, or a transport document capable of being digitized,
a reading system of said label or transport document, configured to transmit and/or connect said code, through a network, to a data storage system, and
a data storage system including:
   a list of codes associated with said raw materials,
   a list of certificates of analysis of the raw materials.

Each code of the list of codes corresponds to a raw material and to at least one certificate of analysis of the raw material.

### TECHNICAL FIELD

The present invention is placed in the field of systems and methods based both on computer technologies and on objects or devices and physical passages that allow traceability and to guarantee the quality of raw materials.

### BACKGROUND OF THE INVENTION

In the modern industrial world, manufacturing companies have always felt the need to be able to trace the path and arrival times of the raw materials necessary for their productions. Furthermore, in addition to these logistical aspects, companies have always had need to guarantee that the quality of raw materials is constant and comprised within certain specifications. To this end, each batch of raw material is accompanied by a certificate of analysis (Certificate of analysis (CoA)), which often takes the form of one or more paper sheets or PDF files that are exchanged between the supplier and the receiving company of said raw material.

It is therefore evident that since the only element that correlates the physical batch of raw material with the relative accompanying analytical documentation is only the batch number, and having said that these are documents that can be easily manipulated fraudulently, it may happen that the actual quality of the exchanged raw material does not correspond to the real one.

Therefore, a problem felt today is that to ensure that each physical batch of raw material univocally corresponds to one or more certificates of analysis that cannot be modifiable or alterable, even intentionally. water content can have a very heavy impact on the actual costs of the transactions, or, it is also felt in the case of raw material considering industrial wastes as it is mandatory the veracity of the analytical results in order not to incur offences of environmental nature.

Nowadays, blockchain technologies are being developed that allow secure transactions, such as banking transactions. However, taken as such, they do not solve the problem of guaranteeing the quality of raw materials.

WO2019246627 discloses systems and methods to facilitate the transfer of funds using blockchain networks, digitized financial credit (e.g. digital tokens), smart contracts, several financial clearing institutions, preference for push-only transfers (over pull-type transfers) and/or graphic codes, such as QR code.

Merchant 306 can send a QR code request 320 to the funds transfer server 304. Then, the funds transfer server can generate a QR code 322 which can encode information about the transaction. The server can send 324 the QR code to the merchant, who can include it 326 on the invoice to be sent to the customer. For example, the QR code can be printed on a paper invoice or attached or included in an electronic invoice. Then, the merchant 306 can provide 328 the invoice with the QR code to the customer 302. Upon receipt of the invoice, the customer can use an optical sensor of his/her device 310 (for example mobile phone, tablet, computer, etc.) to scan 330 the QR code on the invoice. After the scan, user's device 310 can send a request 332 to the funds transfer server, requesting information on the transaction. Upon receipt of the request, the server can retrieve 334 the transaction information associated with the QR code and send 336 the transaction information to the customer on the display of the user's device 310. The customer can then verify 338 the correctness of information, whether accurate, the customer can proceed with the payment notices that the transaction information is inaccurate, he can notify to the server about this inaccuracy, for example by sending error notices or complaints to the server which will communicate them to the merchant.

US2018096175A1 discloses a distributed manufacturing platform and related techniques that connect designers, manufacturers, couriers, and other entities and simplify the process of manufacturing and supplying products. According to that method, an item is packaged using blockchain-enabled 3D printed packaging used to improve the visibility, efficiency, and cross-border transport of the supply chain. For example, when the shipper authenticates the package at the pick-up point (for example, by scanning a barcode, a QR code or other code), the payment for the shipment can be received in accordance with the established agreement with the courier, which is represented by a blockchain-based data set. Similarly, when the package crosses an international border and has to pay a rate, import tax, VAT or similar, this payment can be automatically issued at the crossing point (for example, in response to the package authentication using QR code or other methods), always in accordance with the established contract on the blockchain. This increases the efficiency and reduces the likelihood of fraud or corruption.

### SUMMARY OF THE INVENTION

The problem addressed by the present invention is therefore that of providing a system and a method that allows to solve, at the same time, all the aforementioned problems, in other words, that allows tracing and/or guaranteeing the quality of raw materials (2) effectively solving all the situations listed above.

Therefore, the present invention solves the aforementioned problem by means of the system (1) and the methods that employ it as outlined in the attached claims, whose and methods therefore which allow to avoid fraud or crimes relating to the quality of raw materials, including industrial wastes.

Moreover, as an additional advantage, the proposed solution consists of a system of relatively simple constitution.

Further features and advantages of the system (1) of the invention and of the methods of use will result from the description of the examples of realization of the invention, provided as an indication of the invention.

### DETAILED DESCRIPTION OF THE INVENTION

For the purpose of description of this document, the term “and/or”, when used in a list of two or more items, means that any of the listed items can be used alone, or in any combination of two or more of the listed items.

For example, whether a combination is described as containing components A, B and/or C, or, A and/or B and/or C, the composition may contain only A; only B; only C; A and B in combination; A and C in combination; B and C in combination; or A, B and C in combination.

The terms “comprises”, “comprising” or any other variation thereof, means to cover a non-exclusive inclusion, so that a system, method, use, etc. which includes a list of elements, that does not only include those elements, but may include other elements not expressly listed or related to that system, method, use, etc.

An element followed by “comprises . . . a . . . ” does not prevent, without further constraints, the existence of further identical elements in the system, method or use which comprises the element. of raw materials (2) and/or the transfer or exchange comprising or, alternatively, consisting of the following elements:
a) an analytical system (8) suitable for carrying out chemical, and/or chemical-physical and/or physical analysis on raw materials (2),
b) a label (3) comprising a code (4), or a transport document capable of being digitized,
c) a reading system (5) of said label (3) or transport document, suitable for transmitting and/or connecting said code (4), through a web network or other similar system, to a data storage system (6),
d) a data storage system (6) comprising:
   a list of codes (7) associated with these raw materials (2),
   a list of certificates of analysis (9) of these raw materials (2);
wherein each code (4) of the list of codes (7) corresponds to a raw material (2) and to one or more certificates of analysis of said raw material (2).

It was in fact surprisingly found that the system (1) of the invention allows not only to trace the movements of raw materials, but also to effectively guarantee their quality.

Indeed, the object of the invention is therefore a system and a method that allows the exchange of raw materials which, through the management of transactions based on a blockchain system, manages to simultaneously guarantee the execution of operations in logistical terms, the qualitative security (by uploading the analysis and generating a code (4) to be applied to the bill of lading and containers) and financial security, i.e. payment issued automatically by the system once the coincidence between the ordered and received product has been verified, even in qualitative terms. system: the dedicated operator loads the analysis into a blockchain system by generating an identification code (4) which is applied to the bill of lading and containers, so that the buyer is sure of the origin and quality of the wares, simply by framing the code in the bill of delivering and on the containers upon receipt.

Financial security is guaranteed by that the payment, totally or partially, will be released to the seller from an escrow or through a double transaction, only upon receipt of the ware, in that the smart contract connected to the code (4) and to the platform in general, it allows to automatically release the money once the coincidence between the ordered and received product has been verified.

The system (1) for tracing and guaranteeing the quality of raw materials (2) can also be used to guarantee and/or inform about commercial transactions of raw materials.

The system (1) allows to connect the information about the quality of the material stored in a data storage system (6) also based on the use of the blockchain or other similar system by reading the code (4) of the label (3), thus connecting the data storage system information (6) with the raw material (2), then the passage from the label (3) with the code (4) to the raw material (2).

Raw material (2) means raw materials in general, such as, for example, organic, non-organic raw materials, commodities, food raw materials, cereals, corn, rice, soy, oats, flour, chemical compounds, byproducts, wastewater and/or industrial processing wastes, plastic matters, steel, food ingredients, chemical compositions, food compositions, pharmaceutical compositions, pharmaceutical products, commodities, vaccines, semi-finished products, processed products, and byproducts deriving from a transformation process. guaranteeing the quality and/or the transfer or exchange of raw materials (2), wherein said raw materials are chosen from cereals, corn, rice, soy, oats, flour, chemical compounds, byproducts, waste and/or waste from industrial processing, food ingredients, chemical compositions, food compositions, pharmaceutical compositions, pharmaceutical products, commodities, vaccines, semi-finished products, processed products, and byproducts deriving from a transformation process.

The system (1) of the invention can further comprise e) a web network or other similar system suitable for transmitting and/or connecting said code (4) to a data storage system (6).

The system (1) of the invention can further comprises f) a software and/or an App suitable for managing and/or connecting the various parts of the system (1).

The web network or other similar system can be a web network or other similar system protected by encryption.

The analytical system (8) of step a) is chosen between laser or infrared 3D scanner, Liquid Chromatograph H PLC, H PLC/MS, HPLC/MS-MS, Thin-Layer Liquid Chromatography TLC, Gas Chromatograph GC, GLC, GC/MS, GC-HS, IR, FT-IR or UV-Vis spectrophotometer, Mass Spectrometer, Nuclear Magnetic Resonance Spectrometer, Thermogravimetry TGA, Differential Scanning calorimeter DSC, Karl Fischer Titrator, Near Infra-Red Spectrometry (NIR), XRF Spectrophotometry (X-Ray Fluorescence).

According to an embodiment, the label (3) may include an NFC (Near Field Communication) transmitter/receiver. characteristic of destroying itself if it is removed and/or of leaving a distinctive mark in case of removal.

According to a more preferred embodiment, the label (3) can be an adhesive label which comprises a button connected to a communication system, wherein at least the button is placed on part of the adhesive surface of the adhesive label. In this way, when the adhesive label (2) is detached from the raw material (2) or from the container that contains it, the button is released causing the emission of a signal by the communication system which is sent to the data storage system (6), which records the tampering with the adhesive label.

According to an embodiment, the label (3) can be a tag, for example a tag made of metallic material, which is screwed, welded or riveted onto the raw material (2) or onto the container or container that contains the raw material (2).

According to a preferred embodiment of the system (1), the label (3) is an adhesive label, a sewn label, a glued label, a printed label, varnished or painted or fire-branded or stamped with cryptographic ink, or with a DNA fragment, or it is a tag.

According to an embodiment of the system (1), the label (3) is a self-destructing label.

According to a preferred embodiment of the system (1), the label (3) is a self-destructing adhesive label.

According to a preferred embodiment of the system (1), the label (3) is a self-destructing label, like an adhesive label, a sewn label, a glued label, a printed, varnished or painted or fire-branded label or stamped with cryptographic ink, or a self-destructing tag.

The label (3) comprises a code (4), wherein the code (4) is a univocal identifying code. This code (4) can therefore be a one-dimensional and/or two-dimensional and/or alphanumeric code, such as a QR-code, an alphanumeric code, a matrix code, a bar code or a DNA code; created by fire branding or it is any other code able to identify uniquely a product or item.

According to an embodiment, the label (3) can be made with a DNA fragment. DNA fragment means a sequence of DNA, preferably containing about 100 nucleotidic bases, which is a unique code. Each DNA fragment given by a different combination of the nucleotidic bases provided thus an unique code. The DNA fragment, is a substance, which can be applied, for instance by spraying, over the raw material (2), being thus a special kind of label (3) comprising the code (4). In the case where the label (3) is a DNA fragment, the reading system (5) is a DNA analyzer. Each DNA fragment has a unique DNA sequence which encodes a unique code, suitable for encoding each raw material.

Said DNA fragment means a DNA fragment which can also comprise further compounds chemically bonded to the DNA fragment such, for instance, sugars, proteins, small molecules, etc.

Therefore, the label (3) can be itself constituted by a DNA sequence. Alternatively, the DNA sequence can be applied over an adhesive label wherein the outer surface is covered, at leas partially, with the DNA sequence.

According to a preferred embodiment, the DNA fragment is consist of a DNA sequence containing from 90 to 110 nucleotidic bases. According to a more preferred embodiment, the DNA fragment is a 100 nucleotidic bases DNA sequence.

The DNA fragment can be easily produced with a DNA synthetized and, the code can be read from the DNA fragment by using a DNA analyser capable of transmitting data with the data storage system (6) of the invention. means of cryptographic ink of the QR-code type, alphanumeric code, matrix code or bar code.

According to a more preferred embodiment of the system (1), the code (4) is a code made by means of cryptographic ink of the QR-code type.

According to a more preferred embodiment of the system (1), the label (3) is an adhesive label, a glued label, a printed label, a label stamped with cryptographic ink or with a DNA fragment, or it is a tag and the code (4) is a QR-code, an alphanumeric code, a matrix code, a bar code; and/or is a code made by cryptographic ink.

The code (4), in addition to being present on the label or in the label (3), is also present in a data storage system (6).

The label (3), in addition to the code (4), can further comprise a NFC transmitter/receiver suitable for transmitting to a reading system (5) able to receive NFC information, in particular, able to receive the code (4).

The reading system (5) can be a mobile device, able to receive NFC information, such as for example a Tablet, a Smartphone, preferably a smartphone.

In the case that the reading system (5) is a mobile device, the information retrieved from the data storage system (6) about tracing and quality can be directly displayed on said mobile device, when it is placed in proximity of the raw material (2).

Therefore, for example, the user can place the mobile device near to the label (3) placed on the raw material (2) or on the container that contains it, the label will transmit the code (4) to the mobile device via NFC and, through the code (4), the mobile device, transmitting and/or connecting to the data storage system (6) will show information about the tracing and quality of the raw material (2). near to a barrel or container containing the raw material to know, through the system (1) of the invention, what is the quality of said raw material, i.e. to know one or more certificates of analysis of said raw material. Or, it will be sufficient to place the mobile device, for example the Smartphone, near to a barrel or container containing the raw material to know, through the system (1) of the invention, the transactions and/or physical movements that said material has undergone.

According to an alternative embodiment of the invention, the system of the invention, instead of a label (3), comprise a transport document capable of being digitized. An examples of transport document is a delivery note, bill of lading, goods discharge note. Such a transport document, through a reading system (5) is digitalized thus providing a code (4), which is the transport document itself. After the transport document is digitalized, a digital certificate is produced and then managed through the data storage system (6) of the invention.

According to an alternative, the transport document can also be digital native document and not just a scan or a photography.

The transport document, for example the bill of loading and unloading, is the one that legally gives proof of the movement and existence of the goods. The raw materials are “digitized” from the transport document information by reading, scanning or photographing it through an appropriate reader, thus creating a digital certificate that integrates the information on the physical transport document with any other information available and this digital certificate becomes the pivot of every sale.

So, for example, if 200 tons of soybeans are sold by Caio, such a raw material is represented by its digitalization wherein such a digitalization can be in blockchain o with a smart contract if a blockchain is used) is created with which that specific commodity is bought, which is analysed and a digital identity is created. The digital identity is created by scanning and digitizing the bill. The system or platform associates that transport document and that commodity with a unique digital identity that then allows to do all those other things (transfer, financial, etc.). What matters are the transport documents that identify where the commodity is, what the commodity is, the quality and who owns it. This information is digitized, aggregated and coordinated so that those who buy are certain of what they are buying.

The reading system (5) of said label (3) suitable for transmitting and/or connecting said code (4), through a web network or other similar system, to a data storage system (6), it can be a reader of codes, for example a laser scanner or a NFC reader or receiver.

The reading system (5) can be a mobile device, able to read codes, for example bar codes, QR-Code, matrix codes, such as a Tablet, and it can be for example a Smartphone, preferably it is a smartphone.

The data storage system (6) can be the internal memory or the Hard-Disc of a server, a computer, a mobile device, a PC, etc.

The data storage system (6) can also be part of an IT platform, hereinafter referred to as platform.

Preferably, the data storage system is a blockchain data storage system.

Preferably the data storage system (6) is part of a blockchain platform. More preferably, this data storage system (6) is the closed central or smart-lock type.

This data storage system (6) allows to access and find information regarding that specific raw material (2). comprises at least the following two fields:
code (4), and/or
one or more certificates of analysis.

The platform can be a web platform, and/or as an auxiliary system applicable through API

(application programming interface) to third-party sites or plug-in to platforms, e-commerce or other online activities that have as their object the buying and selling (or other exchange of ownership) of real estate, in particular, raw materials.

This information therefore includes the analytical certificates of the considered raw material (2).

The certificates of analysis can be issued by the producer of the raw material (2) or by third parties.

Certificates of analysis may comprise the results of one or more of the following analysis:
laser or infrared 3D scanning, or by other machineries or such to detect the shape of the raw material (2),
HPLC, HPLC/MS, HPLC/MS-MS, TLC, GC, GLC, GC/MS, GC-HS analysis, IR, FT-IR or UV-Vis spectrophotometry, Mass Spectrometry, Nuclear Magnetic Resonance, TGA, DSC, Residual ash content; loss on drying (LOD), water content, Karl Fischer (KF); Near Infra-Red (NIR) Spectrometry, XRF Spectrophotometry (X-Ray Fluorescence);
organoleptic analysis (tactile, olfactory, visual).

The system (1) therefore allows to guarantee the quality of raw materials and prevent them counterfeiting through a constantly updated data archiving system (6) available for consultation which allows, with full transparency, to verify the analytical results, i.e. the certificates of analysis to guarantee the quality of the raw material (2), as above described. techniques listed above is particularly useful in the case of food raw materials or industrial processing wastes.

This invention guarantees that it is possible to combine uniquely one or more certificates of analysis with a raw material without the possibility that this certificate of analysis (CoA) will be exchanged or modified.

Through the blockchain system it is possible to create a platform that allows to manage the certificates of analysis of raw material (2). The blockchain is indeed able to contain univocal information about the raw material.

According to an aspect of the invention, the system (1) can also comprise unique tokens, named Non Fungible Tokens (abbreviated NFTs), wherein NFT is a type of cryptographic token that guarantees the quality and quantity of the product in digital format.

This digitization of the product makes it possible to uniquely identify a batch of raw materials with the related information. It then allows to enter this lot in a sale which, as mentioned, can be managed in blockchain (if there is NFT) or with a traditional database according to the explanation provided in the following paragraph.

The use of Non-Fungible Tokens (NFTs) has an important development in blockchain technology. NFTs are units of data stored on a blockchain to certify the originality of various digital properties. In the system (1) NFTs can be used to save the originality of ownership and change in the ownership. NFT refers to unique crypto tokens that are managed on the blockchain. The main difference between NFTs and other traditional database is interchangeability. NFTs are coded to have unique IDs and other metadata that no other token can replicate. The NFT can be connected to a virtual certificate, a virtual replica (like 3D or other images of the product), and/or with the ownership in the code. A smart contract such as verifying the ownership and managing the change of ownership using the NFTs. Traditionally, the change in ownership only transfers if the copyright's owner evidences in writing that they intend to transfer those rights alongside the copy of the work. Unless the NFT owner has received explicit permission from the seller and the platform, the NFT owner does not automatically acquire the legal right to further sale the product. The platform has a central authority to determine the change of ownership. The platform can alternatively be one mandatory part in the smart contract (so without its consent the property does not change) or a validator of the blockchain system (this is according to the new created so called consensus mechanism name “Proof of Work”. Here an explanation: A consensus mechanism is a fault-tolerant mechanism that is used in computer and blockchain systems to achieve the necessary agreement on a single data value or a single state of the network among distributed processes or multi-agent systems, such as with cryptocurrencies. It is useful in record-keeping, among other things. On the Bitcoin blockchain, for instance, the consensus mechanism is known as Proof-of-Work (PoW), which requires the exertion of computational power in order to solve a difficult but arbitrary puzzle in order to keep all nodes in the network honest. The proof of work (PoW) is a common consensus algorithm used by the most popular cryptocurrency networks like bitcoin and litecoin. It requires a participant node to prove that the work done and submitted by them qualifies them to receive the right to add new transactions to the blockchain.

However, this whole mining mechanism of bitcoin needs high energy consumption and a longer processing time. The proof of stake (PoS) is another common consensus algorithm that evolved as a low-cost, low-energy consuming alternative to the PoW algorithm. It involves the allocation of responsibility in maintaining the public ledger to a participant node the drawback that it incentivizes cryptocoin hoarding instead of spending. While PoW and PoS are by far the most prevalent in the blockchain space, there are other consensus algorithms like Proof of Capacity (PoC) which allow sharing of memory space of the contributing nodes on the blockchain network. The more memory or hard disk space a node has, the more rights it is granted for maintaining the public ledger. Proof of Activity (PoA), used on the Decred blockchain, is a hybrid that makes use of aspects of both PoW and PoS. Proof of Burn (PoB) is another that requires transactors to send small amounts of cryptocurrency to inaccessible wallet addresses, in effect “burning” them out of existence. Another, called Proof of History (PoH), developed by the Solana Project and similar to Proof of Elapsed Time (PoET), encodes the passage of time itself cryptographically to achieve consensus without expending many resources.

In order to track and buy the product, it is necessary to transport the product. This aspect is particularly for large loads. The system and/or method or platform of the invention also puts the transporter in contact, allowing him to identify and track the goods that are always identified. This is a key part of commodity trading.

Another object is a method for tracing and guaranteeing the quality or the change of ownership of raw materials (2) by means of the system (1) above described comprising or, alternatively, consisting of the following steps:
a) providing the above described system (1),
b) carrying out one or more chemical and/or chemical-physical and/or physical analysis on a raw material (2) and producing one or more certificates of analysis
c) producing in the data storage system (6) a record comprising:
   a code (4) associated with a raw material (2),
wherein each code (4) corresponds to a raw material (2) and to one or more certificates of analysis of said raw material;
d) producing a label (3) comprising the code (4) of step c),
e) applying the label (3) of step d) on the bill of lading or delivering and/or on the container containing said raw material (2),
f) by means of a reading system (5) reading said label (3) and transmitting said code (4), through a web network or other similar system, to the data storage system (6), g) the data storage system (6) returns the tracing and the certificate(s) analysis of said raw material (2).

Step d) can be carried out by printing, including or stamping the code (4) in or on the label (3) and/or on the raw material itself (2) or on the container of the raw material (2).

With regard to the transfers of ownership of the raw material, it is considered, by way of example, the situation wherein the raw material (2) is owned by Tizio and he wants to sell it to Caio. Caio on the platform will send a purchase proposal to Tizio (or vice versa), whether accepted by Tizio, he sends the raw material to Caio, while the money is kept by the platform as an escrow or double transaction. Once the raw material has been received, Caio frames the code or enters it in the data storage system (6), in this way the platform manages, manually or automatically, the transfer of information about the ownership of the raw material (Smart Contract) and, if chosen, also the transfer of money to Tizio.

Raw materials often cost a lot and companies often resort to factoring to advance the costs of the goods. The platform will integrate third parties (financial institutions) that advance invoices related to the sale for the buyer through the transfer of the same. The system allows to make the commodity become a collateral (guaranty) for the lender, but generally on the invoice or contract refers.

An other object is a method for tracing and guaranteeing the quality or the change of ownership of raw materials (2) by means of the system (1) according to any one of claims from 1 to 8 comprising or, alternatively, consisting of the following steps:
A2) providing the system (1) according to the description given above,
B2) carrying out one or more chemical and/or chemical-physical and/or physical analysis on a raw material (2) and producing one or more certificates of analysis,
C2) digitalizing of the transport document or providing a digital transport document,
D2) producing in the data storage system (6) a record comprising:
   a code (4) associated with a raw material (2),
   one or more certificates of analysis of the raw material (2),
   the transport document in digital form,
wherein each code (4) corresponds to a raw material (2) and to one or more certificates of analysis of said raw material and one transport document;
E2) producing a digital certificate of the product,

According to an embodiment, said method further comprises the further step of producing a smart contract managed by the blockchain.

According to an other embodiment of said method, the digital certificate is a Non-Fungible Token.

Therefore, according to an embodiment, the above-mentioned methods may comprise the following further steps to manage the transfer of ownership from owner X to the future owner Y:
to future owner Y,
i) optionally, if the purchase proposal or the sale offer is accepted respectively by owner X or by the future owner Y, the future owner Y deposits the compensation in cash (or cryptocurrencies, or barter, exchange of wares for titles or any other form of economic exchange or free-contract) into the platform and/or plug-in by way of escrow and/or double buying and selling, and/or sale with reserve property agreement, loan for use, rental and/or leasing and/or rent or buy, franchising or any other type of contract also concluded with smart contract method,
l) if the purchase proposal or the sale offer is accepted respectively by owner X or by future owner Y, owner X sends the raw material (2) comprising the label (3) comprising a code (4), to the future owner Y,
m) when the raw material (2) has been received, the future owner Y, by means of a reading system (5) of said label (3), transmits said code (4), through a web network or other similar system, to the data storage system (6),
n) the data storage system (6) is then updated, manually or automatically, with regard to the transfer of ownership of good from owner X to owner Y;
o) optionally, the platform releases to owner X the money which, by way of escrow and/or double buying and selling, and/or sale with reserve property agreement, loan for use, rental and/or leasing and/or rent or buy, franchising or any other type of contract also concluded with smart contract method, the future owner Y had deposited into the platform and/or plug-in.

According to an other embodiment, the methods of the invention or platform can comprise the following further steps:
i1) Seller is identified (or rather it is identified its goods and in the case divided into sub lots),
l1) the contract is concluded (smart contract if there is blockchain, or traditional database otherwise),
m1) the buyer pays (or the money is advanced by the financial institution) and money are kept in escrow until delivery,
n1) it comes chosen the transporter who will transport that goods and the lot is optionally divided into loads being transported.

In step b) of the methods, the chemical and/or chemical-physical and/or physical analysis of step b) is chosen from:
laser or infrared 3D scanning, or by other machineries or such as to detect the shape of the raw material (2),
HPLC, HPLC/MS, HPLC/MS-MS, TLC, GC, GLC, GC/MS, GC-HS analysis, IR, FT-IR or UV-Vis spectrophotometry, Mass Spectrometry, Nuclear Magnetic Resonance, TGA, DSC, Residual ash content; loss on drying (LOD), water content, Karl Fischer (KF); Near Infra-Red (NIR) Spectrometry, XRF Spectrophotometry (X-Ray Fluorescence);
organoleptic analysis (tactile, olfactory, visual).

According to a preferred embodiment, in step b) the analysis of the water content is carried out by determination of the Karl Fischer (KF) value.

According to a preferred embodiment of the above-mentioned method, the organoleptic analysis is carried out by visual and/or olfactory and/or tactile analysis.

Thus, an effect provided by the system and/or by the method of the invention is to provide the consumer with the tracing and/or the certificate (s) of analysis of raw material (2). paper certificate of analysis of raw material (2). In such a case, the system (1) further comprises a printer suitable for printing said paper tracing or paper certificate of analysis of the raw material (2).

Moreover, another technical effect provided by the system (1) and/or method of the invention is the supply of a label (3) on the bill of lading or delivering and/or on the container containing said raw material (2).

Another object is the use of a system (1) as above described, including the forms of preferred embodiment, to guarantee the quality of raw materials (2) or to guarantee the traceability and quality, and/or transfer or exchange, of raw materials (2), or to guarantee the change of ownership of raw materials (2).

According to an embodiment, the use of a system (1) as above described is preferred, including the preferred embodiments, to guarantee the quality of raw materials (2) or to guarantee the traceability and quality of raw materials (2).

A further object is a method for identifying the contents of a container comprising or, alternatively, consisting of the following steps:
a1) providing the system (1) as described above,
b1) carrying out one or more chemical and/or chemical-physical and/or physical analysis on a raw material (2) and producing one or more certificates of analysis,
c1) producing in the data storage system (6) a record comprising:
   a code (4) associated with a raw material (2),
   one or more certificates of analysis of the raw material (2),
wherein each code (4) corresponds to a raw material (2) and to one or more certificates of analysis of said raw material;
e1) applying the label (3) of step d1) on the container containing said raw material (2),
f1) by means of a reading system (5) reading said label (3) and transmitting said code (4), through a web network or other similar system, to the data storage system (6),
g1) the data storage system (6) returns the contents of the container in terms of the name of the raw material (2), and, optionally, one or more certificates of analysis of the material (2).

Indeed, this method allows to determine in a very simple, immediate, and not expensive, unambiguously and without the possibility of frauds, the contents of a container containing one or more raw materials (2).

This last method of applying of the method of the present invention allows therefore the fast check of the goods contained in containers, for example, at the Customs, ports, airports, etc.

Another object is the use of a system (1) as above described, including the forms of preferred embodiments, for identifying the contents of a container, in particular in terms of raw material(s) (2).

From the above description they are evident the advantages of the system (1) of the present invention, which, albeit in its relatively simple implementation, solves many problems simultaneously, with one and only one system.

The system and/or method of invention, also includes, the situation wherein, even in absence of the label (3) is possible to uniquely identify the raw material or the raw material batch and/or sub-batches and, through the system and/or the method of the invention it is possible to tracing and to guaranteeing the quality of raw materials. Such a situation are those explained above with reference to the transport document and its digitalization to be the label (3).

From the above description it emerges that the system and/or method of the invention is the only one that allows to trade of raw materials in a safe manner and provides certainty about ownership of the raw materials. This aspect is certainly very important for the system and/or method of the invention.

In fact, even the lack of only one of the elements of the system and/or the steps of the method means that the transaction can have flaws. The system and/or method of the invention therefore allow to have certainty that the raw material or commodity is exactly the one intended to be the subject of the transaction and that it goes from A to B without any problems and without B losing money or receiving a different product.

If a financial company manages this transaction, that company, thanks to the digital certificate or to the label linked to the lot number, is insured on the operation it is financing and on what is the underlying of the operation, and also ensures that it is paid in case of failure of the operation.

1. System for tracing and guaranteeing the quality of raw materials and/or a transfer or exchange thereof, the system comprising:
an analytical system configured to carry out at least one of a: chemical, chemical-physical or physical analysis on raw materials,
a label, comprising a code, or a transport document capable of being digitized,
a reading system of said label or transport document, configured to transmit and/or connect said code, through a network, to a data storage system,
a data storage system comprising:
a list of codes associated with said raw materials,
a list of certificates of analysis of said raw materials; wherein each code of the list of codes corresponds to a raw material and to at least one certificate of analysis of said raw material.

2. The system according to claim 1, wherein the analytical system is chosen from the group consisting of: laser 3D scanner, infrared 3D scanner, Liquid Chromatograph HPLC, HPLC/MS, HPLC/MS-MS, Thin-Layer Liquid Chromatography TLC, Gas Chromatograph GC, GLC, GC/MS, GC-HS, IR, FT-IR or UV-Vis spectrophotometer, Mass Spectrometer, Nuclear Magnetic Resonance Spectrometer, Thermogravimetry TGA, Differential Scanning calorimeter DSC, Karl Fischer Titrator, Near Infra-Red Spectrometry (NIR), and XRF Spectrophotometry (X-Ray Fluorescence).

3. The system according to claim 1, wherein the label is a DNA sequence, or is an adhesive label wherein an outer surface thereof is covered, at least partially, with the DNA sequence.

4. The system according to claim 3, wherein the DNA sequence comprises a DNA fragment containing from 90 to 110 nucleotide bases.

5. The system according to claim 1, wherein the label is an adhesive label, a glued label, a printed label, a label stamped with cryptographic ink, or is a tag; and the code is a QR-code, an alphanumeric code, a matrix code, a barcode or a DNA code; and/or is a code made by cryptographic ink or by a DNA fragment; or the label is a screwed, welded or riveted tag on the raw material or onto a container that contains the raw material.

6. The system according to claim 1, wherein the label is an adhesive label which comprises a button connected to a communication system, wherein at least the button is placed on part of the adhesive surface of the adhesive label.

7. The system according to claim 1, wherein said raw materials are chosen from the group consisting of: cereals, corn, rice, soybeans, oats, flour, chemical compounds, byproducts, waste, waste from industrial processing, food ingredients, chemical compositions, food compositions, pharmaceutical compositions, pharmaceutical products, commodities, vaccines, semi-finished products, processed products, and byproducts deriving from a transformation process.

8. The system according to 1, further comprising Non-Fungible Tokens.

9. Method for tracing and guaranteeing the quality or the change of ownership of raw materials, the method comprising:
a) providing the system according to claim 1,
b) carrying out at least one of a: chemical, chemical-physical or physical analysis on a raw material and producing at least one certificate of analysis,
c) producing in the data storage system a record comprising:
a code associated with a raw material,
at least one of analysis of the raw material,
wherein each code corresponds to a raw material and to at least one certificate of analysis of said raw material;
d) producing a label comprising the code of step c),
e) applying the label of step d) on at least one of: a bill of lading, a bill of delivering or on the container containing said raw material,
f) by means of a reading system, reading said label and transmitting said code, through a network, to the data storage system,
g) the data storage system returns the tracing and the at least one certificate of analysis of said raw material.

10. Method for tracing and guaranteeing the quality or a change of ownership of raw materials, the method comprising:
A2) providing the system according to claim 1,
B2) carrying out at least one of a: chemical, chemical-physical or physical analysis on a raw material and producing at least one certificate of analysis,
C2) digitalizing of the transport document or providing a digital transport document,
D2) producing in the data storage system a record comprising:
a code associated with a raw material,
at least one certificate of analysis of the raw material,
the transport document in digital form,
wherein each code corresponds to a raw material and to at least one certificate of analysis of said raw material and one transport document;
E2) producing a digital certificate of the product.

11. The method according to the claim 10, further comprising: producing a smart contract managed by the blockchain.

12. The method according to claim 10, wherein the digital certificate is a Non-Fungible Token.

13. The method according to claim 9, wherein to manage a transfer of ownership from owner X to future owner Y the method further comprises:
h) the future owner Y sends a purchase proposal to owner X or owner X sends a sale offer to future owner Y,
i) optionally, if the purchase proposal or the sale offer is accepted respectively by owner X or by the future owner Y, the future owner Y deposits payment in cash into the platform and/or plug-in by way of escrow,
l) if the purchase proposal or sale offer is accepted respectively by owner X or by future owner Y, owner X sends the raw material comprising the label comprising a code, to the future owner Y,
m) when the raw material has been received, the future owner Y, by means of a reading system of said label, transmits said code, through a network, to the data storage system,
n) the data storage system is then updated, manually or automatically, with regard to the transfer of ownership of goods from owner X to owner Y;
o) optionally, the platform releases to owner X the payment that, by way of escrow or double transaction, the future owner Y had deposited into the platform and/or plug-in.

14. The method according to claim 9, further comprising:
h1) buyer send offer for a specific lot,
i1) seller is identified,
l1) the contract is concluded,
m1) the buyer pays and the payment is kept in escrow until delivery.
n1) a transporter is chosen who will transport that goods and the lot is optionally divided into loads being transported.

15. The method according to claim 9, wherein the at least one of: chemical chemical-physical or physical analysis is carried out by at least one of:
laser 3D scanning or infrared 3D scanning as to detect a shape of the raw material,
HPLC, HPLC/MS, HPLC/MS-MS, TLC, GC, GLC, GC/MS, GC-HS analysis, IR, FT-IR or UV-Vis spectrophotometry, Mass Spectrometry, Nuclear Magnetic Resonance, TGA, DSC, Residual ash content; loss on drying (LOD), water content, Karl Fischer (KF); Near Infra-Red (NIR) spectrometry, XRF (X-Ray Fluorescence) spectrophotometry or
organoleptic analysis (tactile, olfactory, visual).

16. Method for identifying the contents of a container, the method comprising:
a1) providing the system according to claim 1,
b1) carrying out at least one of: chemical, chemical-physical or physical analysis on a raw material and producing at least one certificate of analysis,
c1) producing, in the data storage system, a record comprising:
a code associated with a raw material,
at least one certificate of analysis of the raw material, wherein each code corresponds to a raw material and at least one certificate of analysis of said raw material;
d1) producing a label comprising the code,
e1) applying the label on the container containing said raw material,
f1) by means of a reading system, reading said label and transmitting said code, through a network to the data storage system,
g1) the data storage system returns the contents of the container in terms of the name of the raw material, and, optionally, at least one certificate of analysis of the raw material.

17. Use of a system according to claim 1, to guarantee the quality of raw materials or to guarantee the traceability and quality of raw materials or to identify the contents of a container or to guarantee the change of ownership of raw materials.
